(19) United States
(12) Patent Application Publication
(10) Pub. No.: US 2011/0277440 A1
(43) Pub. Date: Nov. 17, 2011

(54) SYNTHESIS GAS-BASED FUEL SYSTEM, AND METHOD FOR THE OPERATION OF A SYNTHESIS GAS-BASED FUEL SYSTEM

(76) Inventors: Christian Brunhuber, Auerbach (DE); Jens Keyser, Furth (DE); Oliver Reimuth, Erlangen (DE)

(21) Appl. No.: 13/146,263

(22) PCT Filed: Jan. 11, 2010
(86) PCT No.: PCT/EP10/50186

§ 371 Date: Jul. 26, 2011

(30) Foreign Application Priority Data
Jan. 26, 2009 (EP) 09151350.7

(51) Int. Cl. F02G 3/00; F16L 41/00

(52) U.S. Cl. 60/39.12; 137/561 A

(57) ABSTRACT

A synthesis gas-based fuel system with a main synthesis gas pipe that branches of a gasification device is provided. A synthesis gas storage tank is connected to the main synthesis gas pipe via a first secondary pipe. Further, a method for operating such a synthesis gas-based fuel system is described.

### CROSS REFERENCE TO RELATED APPLICATIONS

This application is the US National Stage of International Application No. PCT/EP2010/050186 filed Jan. 11, 2010, and claims the benefit thereof. The International Application claims the benefits of European Patent Application No. 09151350.7 EP filed Jan. 26, 2009. All of the applications are incorporated by reference herein in their entirety.

### FIELD OF INVENTION

The invention relates to a synthesis gas-based fuel system, especially for a combined-cycle gas and steam power plant, and relates to the problem of rapid changes in load of the gas turbine, as are caused for example by the demands of the UK's grid code. The invention further relates to a method for operation of a synthesis gas-based fuel system for rapid load changes of a gas turbine in synthesis gas-based operation.

### BACKGROUND OF INVENTION

The use of Integrated Gasification Combined Cycle (IGCC) for generation of synthesis gases with subsequent use in a combined-cycle plant (GuD) is viewed as an alternative to conventional steam power plants (DKW), above all in respect of the potential efficiency benefits of the GuD application when compared to DKW. The synthesis gas-based fuel system connected upstream of the combined-cycle system, consisting of the individual components nitrogen thinning, water/steam saturation, natural gas admixture, air removal and heat exchanger, is essential for the operation of an IGCC plant.

The objective of the synthesis gas-based fuel system is the provision of a conditioned synthesis gas in accordance with the temperature and calorific value requirements of the downstream consumer, the gas turbine and, in the event of integration on the air side, the provision of compressed air for integrated use in the air separation plant. The conditioning and thus the calorific value setting of the raw synthesis gas present at the entry into the synthesis gas-based fuel system is undertaken via the above-mentioned individual components/systems. The temperature of the conditioned synthesis gas is set before its exit from the synthesis gas-based fuel system by a heat exchanger. The compressed air is taken in the case of (partly) integrated air removal from the gas turbine compressor, for non-integrated air removal from a separate compressor, and is set by means of integrated heat exchangers to the temperature level required by the air separation plant. DE 100 02 084 C2 describes such a plant.

The synthesis gas-based fuel system, because of the interaction with the involved main systems of the IGCC (air separation system, gasification, gas washing, combined-cycle system) is currently embodied as a subsystem of the overall plant capable of providing base loads, with steep load gradients of the gas turbine not being able to be realized by means of pure synthesis gas mass flow increase.

Since the availability of a method of operation with steep load gradients of the gas turbine in the IGCC configuration while using synthesis gas operation is increasingly demanded, the synthesis gas-based fuel system must be tailored to these changed boundary conditions as independently as possible and with only slight effects on the adjacent main systems.

### SUMMARY OF INVENTION

An object of the claimed invention is thus to specify a synthesis gas-based fuel system for rapid load changes of the gas turbine, and also to specify a method for operating such a system.

Inventively the object directed to a synthesis gas-based fuel system is achieved by a synthesis gas-based fuel system with a main synthesis gas pipe branching off from a gasification device, with a synthesis gas storage tank being connected via a first secondary pipe to the main synthesis gas pipe.

The invention is therefore based on the idea of providing an additional fuel mass flow through a synthesis gas tank. This invention involves a buffering of the conditioned synthesis gas in a storage tank provided for the purpose. The function of the synthesis gas storage tank is to provide the conditioned synthesis gas mass flow needed for a rapid increase in load in the event of a temporary lack of synthesis gas as a result of a restricted load gradient of the gasifier.

Advantageously the synthesis gas storage tank is disposed in the direction of flow of a synthesis gas in a part of the synthesis gas-based fuel system arranged downstream. A rapid increase in load of the complete IGCC plant is linked to the rapid availability of the additionally usable fuel mass flow (synthesis gas) in conjunction with a sufficient calorific value. With the use of an additional fuel mass flow through a synthesis gas tank, in the event of a rapid increase in load as a result of a flow delay of the fuel mass flow before it reaches the gas turbine, resulting from the size and length of the installed units, it must be ensured when carrying out the injection of the additional fuel mass flow (synthesis gas) in the synthesis gas fuel system, that the injection lies as close as possible to the gas turbine.

It is further advantageous for a compressor for establishing the required pressure and a first control valve for regulating the amount of synthesis gas or to regulate the pressure of the synthesis gas storage tank to be connected into the first secondary pipe.

In such cases it is advantageous for the synthesis gas storage tank to be connected via a second secondary pipe to the main synthesis gas pipe and for a second control valve, for defined and rapid regulation of amounts and pressure of the synthesis gas flowing out of the synthesis gas storage tank via the second secondary pipe into the main synthesis gas storage pipe, to be connected into the second secondary pipe.

It is expedient if, to avoid condensation of the conditioned synthesis gas in the synthesis gas storage tank, said tank has a heater. For the same reason it is further expedient for the synthesis gas storage tank to have insulation.

In an advantageous embodiment of the invention a blockable drainage pipe branches off from the synthesis gas storage tank, so that in the event of the synthesis gas storage tank being shut down, the tank can be emptied of liquid condensate.

Advantageously the synthesis gas storage tank is connected via a pressure monitoring facility to a flare. The pressure monitoring facility with safety valve prevents the maximum permissible pressure of the synthesis gas in the synthesis gas storage tank from being exceeded. If the pressure in the synthesis gas storage tank rises the safety valve allows the synthesis gas to escape to the flare, with which the superfluous gases are burned.

Advantageously the inventive synthesis gas-based fuel system, in a combined-cycle turbine system with a gas turbine, is connected upstream of a combustion chamber of the gas turbine, whereby the main synthesis gas pipe opens out into the combustion chamber and whereby a saturator is connected into the main synthesis gas pipe and the synthesis gas storage tank is connected between the saturator and the combustion chamber.

In the inventive method for operating a synthesis gas-based fuel system for rapid changes in load of a gas turbine in synthesis gas mode an excess of synthesis gas provided is introduced into a synthesis gas storage tank and is taken from the synthesis gas storage tank again as required until a gasification device can fully provide a synthesis gas mass flow needed. In accordance with the invention the conditioned synthesis gas is buffered in a storage tank provided for the purpose.

Advantageously the synthesis gas is conditioned before being introduced into the synthesis gas storage tank, so that if required it can be immediately made available correctly conditioned.

It is further advantageous for the synthesis gas to be compressed before its introduction into the synthesis gas storage tank.

### BRIEF DESCRIPTION OF THE DRAWINGS

The invention will be explained in greater detail by way of examples which refer to the drawings. The drawings, which are schematic and not to scale, show

FIG. 1 a known synthesis gas-based fuel system and

FIG. 2 a synthesis gas-based fuel system in accordance with the invention with a synthesis gas storage tank.

### DETAILED DESCRIPTION OF INVENTION

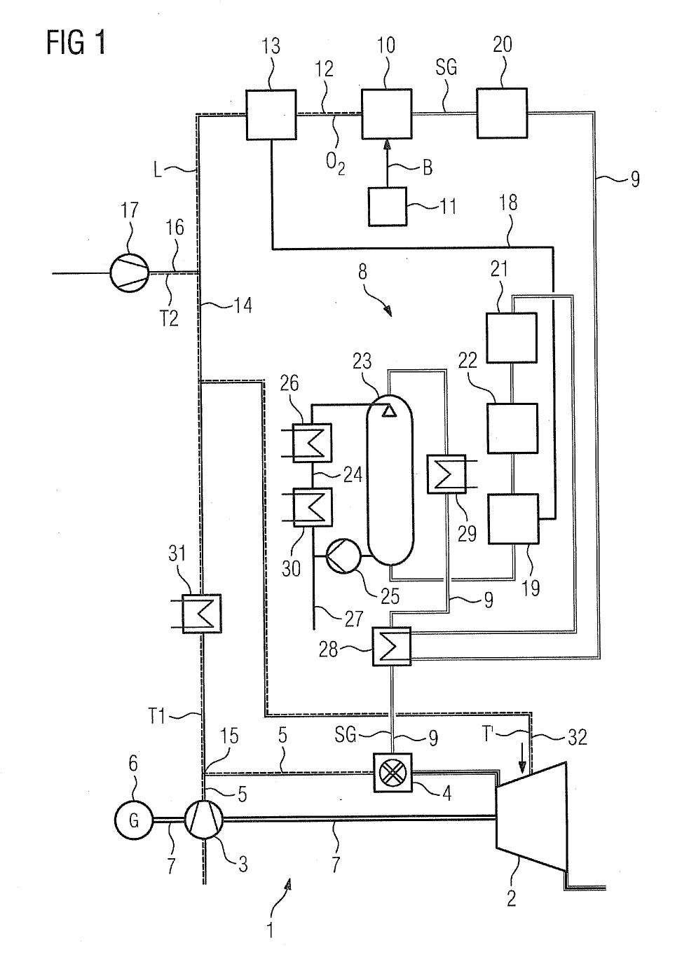

A known combined-cycle gas and steam turbine system comprises a gas turbine system 1 in accordance with FIG. 1 and a steam turbine system not shown in greater detail. The gas turbine system 1 comprises a gas turbine 2 with coupled air compressor 3 and a combustion chamber 4 connected upstream of the gas turbine 2, which is connected to a compressed air pipe 5 of the compressor 3. The gas turbine 2 and the air compressor 3 as well as a generator 6 sit on a common shaft 7.

The gas turbine system 1 is designed to be operated with a gasified raw gas or synthesis gas SG, which is created by gasification of a fossil fuel B. Gasified coal or gasified oil can typically be provided as the synthesis gas. To this end the gas turbine system 1 includes a synthesis gas-based fuel system 8, via which synthesis gas is able to be supplied to the combustion chamber 4 of the gas turbine 2. The synthesis gas-based fuel system 8 includes a main synthesis gas pipe 9, which connects a gasification device 10 to the combustion chamber 4 of the gas turbine 2. The gasification device 10 is able to be supplied via an input system 11 with coal, natural gas, oil or biomass as a fossil fuel B for example. Furthermore the synthesis gas-based fuel system 8 includes components which are connected into the main synthesis gas pipe 9 between the gasification device 10 and the combustion chamber 4 of the gas turbine 2.

To provide the oxygen O₂ needed for the gasification of the fossil fuel B the gasification device 10 is connected upstream via an oxygen pipe 12 of an air separation device 13. The air separation device 13 is able to have an airflow L applied to it on its input side which is composed of a first part flow T1 and a second part flow T2. The first part flow T1 is able to be taken from the air compressed in the air compressor 3. For this purpose the air separation device 13 is connected on its input side to an air removal pipe 14, which branches off at a branch point 15 from the compressed air pipe 5. A further air pipe 16 also opens out into the air removal pipe 14, in which an additional compressor 17 is connected and via which the second part flow T2 is able to be supplied to the air separation system 13. In the exemplary embodiment the overall air flow L flowing into the air separation device 13 is thus composed of the part flow T1 branched off from the compressed air pipe 5 (minus a sub flow T′ explained below) and of the airflow T2 demanded from the additional air compressor 17. A circuit concept of this type is also referred to as a part-integrated plant concept. In an alternative embodiment, the so-called fully integrated plant concept, the further air pipe 16 along with the additional air compressor 17 can be dispensed with, so that the air separation device 13 is completely supplied with air via the part flow T1 taken from the compressed air pipe 5.

Connected into the air removal pipe 14 is a heat exchanger 31 in order to recover heat from the removed air, which enables an especially high efficiency of the combined-cycle plant to be achieved.

Viewed in the flow direction of the part flow T1 behind the heat exchanger 31, a cooling air pipe 32 branches off from the air removal pipe 14, via which a part quantity T′ of the cool part flow T1 is able to be supplied to the gas turbine 2 as cooling air for blade cooling.

The nitrogen N₂ obtained in the air separation system 13 during the separation of the air flow L in addition to the oxygen O₂ is supplied to a mixing facility 19 via a nitrogen pipe 18 connected to the air separation system 13 and mixed into the synthesis gas SG there. The mixing facility 19 is embodied in this case for an especially uniform mixing of the nitrogen N₂ and the synthesis gas SG without any cold currents.

The synthesis gas SG flowing out of the gasification device 10 arrives via the main synthesis gas pipe 9 initially in a synthesis gas waste heat steam generator 20 in which through heat exchange with a flow medium the synthesis gas SG is cooled down. High-pressure steam generated in this heat exchange can be supplied in a way not shown in any greater detail to a high-pressure stage of a water-steam circuit of a steam turbine plant.

Viewed in the flow direction of the synthesis gas SG beyond the synthesis gas waste heat steam generator 20 and before a mixing facility 19, a dust removal device 21 for the synthesis gas SG as well as a sulfur removal device 22 are connected into the main synthesis gas pipe 9. In an alternative embodiment, instead of the dust removal device 21, especially in the case of gasification of oil as fuel, a soot washing facility can be provided.

For an especially low pollutant emission in the combustion of the gasified fuel in the combustion chamber 4 charging of the gasified fuel with water vapor before entry into the combustion chamber 4 is provided. This can be undertaken in an especially advantageous manner in thermotechnical terms in a saturator system. For this purpose a saturator 23 is connected into the main synthesis gas pipe 9 in which the gasified fuel is routed in an opposing flow to heated saturator water. The saturator water circulates in this case in a saturator circuit 24 connected to the saturator 23, in which a recirculation pump 25 as well as a heat exchanger 26 to preheat the saturator water are connected. To compensate for the losses of saturator water arising during the saturation of the gasified fuel a feed pipe 27 is connected to the saturator circuit.

Viewed in the flow direction of the synthesis gas SG beyond the saturator 23, a heat exchanger 28 is connected into the main synthesis gas pipe 9 on the secondary side acting as a synthesis gas-mixed gas heat exchanger. The heat exchanger 28 in this case is likewise connected on the primary side at a point before the dust removal device 21 into the main synthesis gas pipe 9, so that the synthesis gas SG flowing toward the dust removal device 21 transfers part of its heat to the synthesis gas SG flowing out of the saturator 23. The routing of the synthesis gas SG via the heat exchanger 28 before its entry into the sulfur removal device 22 can also be provided for a circuit concept modified in respect of the other components. Especially with the connection of a soot washing device, the heat exchanger can preferably be arranged on the synthesis gas side downstream of the soot washing device.

Connected between the saturator 23 in the heat exchanger 28 in the main synthesis gas pipe 9 on the secondary side is a further heat exchanger 29, which can be feed water heated on the primary side or also steam heated. Through the heat exchanger 28 embodied as a synthesis gas-pure gas heat exchanger and the heat exchanger 29 an especially reliable preheating of the synthesis gas SG flowing to the combustion chamber 4 of the gas turbine 2 is guaranteed even for different operating states of the combined-cycle plant.

For heat decoupling in the saturator circuit 24, a saturator water heat exchanger 30 is provided in addition to the heat exchanger 26, to which for example heated feed water split off after the feed water preheater can be applied, to which on the primary side feed water from a feed water container not shown in the diagram can be applied.

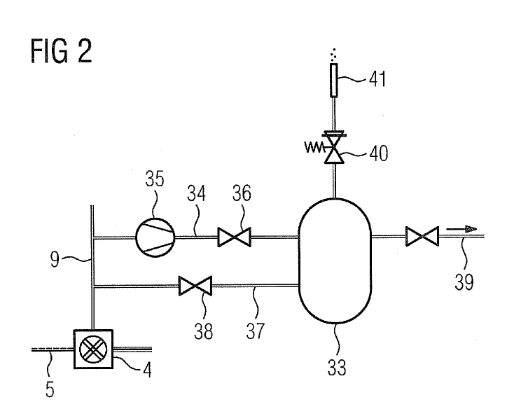

FIG. 2 describes the inventive synthesis gas-based fuel system 8, in which the conditioned synthesis gas is removed during synthesis gas operation of the IGCC plant before the combustion chamber 4 via a first secondary pipe 34 of the main synthesis gas pipe 9, compressed to storage pressure by means of a compressor 35 and introduced into the synthesis gas storage tank 33. The synthesis gas storage tank 33 is connected by means of a first control valve 36 which is connected into the first secondary pipe 34, for explicitly controlling the quantity and pressure of the synthesis gas storage tank 33.

Synthesis gas is removed from the synthesis gas storage tank 33 via a second secondary pipe 37 by which the synthesis gas storage tank 33 is connected to the main synthesis gas pipe 9 and by means of a second control valve 38, which is connected into the second secondary pipe 37, for defined and rapid regulation of the quantity and pressure of synthesis gas flowing into the main synthesis gas pipe 9 from the synthesis gas storage tank 33 to the predetermined gas turbine entry pressure. To avoid condensation of the conditioned synthesis gas in the synthesis gas storage tank 33 said tank is held during operation by means of heating and insulation to a temperature with a sufficient distance to the saturator pipe of the water in the synthesis gas. In the event of the synthesis gas storage tank 33 being shut down, liquid condensate is emptied out of the latter via blockable drain pipes 39. The pressure of the synthesis gas storage tank 33 for filling, storage and emptying with synthesis gas is monitored via a pressure monitoring facility 40 with a safety valve for venting to the flare 41 if the permitted overpressure is exceeded. The pressure in and the storage volume of the synthesis gas storage tank 33 is defined by the synthesis gas mass flow needed for rapid changes of the gas turbine 2, until the gasification device 10 because of its restricted load gradients can fully provide the synthesis gas mass flow.

1-13. (canceled)

14. A synthesis gas-based fuel system, comprising:
a gasification device;
a main synthesis gas pipe branching off from the gasification device;
a synthesis gas storage tank for removing synthesis gas from the main synthesis gas pipe, wherein the synthesis gas storage tank is connected via a first secondary pipe to the main synthesis gas pipe.

15. The synthesis gas-based fuel system as claimed in claim 14, wherein the synthesis gas storage tank is disposed in a flow direction of a synthesis gas in a downstream part of the synthesis gas-based fuel system.

16. The synthesis gas-based fuel system as claimed in claim 14, further comprising:
a compressor which is connected to the first secondary line.

17. The synthesis gas-based fuel system as claimed in claim 14, further comprising:
a first control valve
for regulating synthesis gas or
for regulating a pressure of the synthesis gas storage tank connected to the first secondary pipe.

18. The synthesis gas-based fuel system as claimed in claim 14, wherein the synthesis gas storage tank is connected via a second secondary pipe to the main synthesis gas pipe, and wherein a second control valve is connected to the second secondary pipe.

19. The synthesis gas-based fuel system as claimed in claim 14, wherein the synthesis gas storage tank comprises a heater.

20. The synthesis gas-based fuel system as claimed in claim 14, wherein the synthesis gas storage tank comprises insulation.

21. The synthesis gas-based fuel system as claimed in claim 14, further comprising:
a blockable drainage pipe branching off from the synthesis gas storage tank.

22. The synthesis gas-based fuel system as claimed in claim 14, wherein the synthesis gas storage tank is connected via a pressure monitoring facility to a flare.

23. A combined-cycle power plant, comprising:
a gas turbine;
a synthesis gas-based fuel system which is connected upstream of a combustion chamber of the gas turbine, the synthesis gas-based fuel system comprising
a gasification device;
a main synthesis gas pipe branching off from the gasification device;
a synthesis gas storage tank for removing synthesis gas from the main synthesis gas pipe, wherein the synthesis gas storage tank is connected via a first secondary pipe to the main synthesis gas pipe,
wherein the main synthesis gas pipe is connected to the combustion chamber,
wherein a saturator is connected to the main synthesis gas pipe, and
wherein the synthesis gas storage tank is arranged between the saturator and the combustion chamber.

24. A method for operating a synthesis gas-based fuel system for rapid changes in load of a gas turbine, comprising:
providing a synthesis gas;
introducing the synthesis gas into a synthesis gas storage tank; and
removing the synthesis gas on demand from the synthesis gas storage tank until a gasification device fully provides a required synthesis gas mass flow.

25. The method as claimed in claim 24, wherein the synthesis gas is conditioned before introducing the synthesis gas into the synthesis gas storage tank.

26. The method as claimed in claim 24, wherein the synthesis gas is compressed before introducing the synthesis gas into the synthesis gas storage tank.

27. The method as claimed in claim 25, wherein the synthesis gas is compressed before introducing the synthesis gas into the synthesis gas storage tank.
